(19) United States
(12) Patent Application Publication
(10) Pub. No.: US 2020/0376771 A1
(43) Pub. Date: Dec. 3, 2020

(54) FABRICATING SYSTEM, CONTROL DEVICE, AND FABRICATING METHOD

(71) Applicant: Takahide MAEDA, Kanagawa (JP)

(72) Inventor: Takahide MAEDA, Kanagawa (JP)

(73) Assignee: Ricoh Company, Ltd., Tokyo (JP)

(21) Appl. No.: 16/854,072

(22) Filed: Apr. 21, 2020

(30) Foreign Application Priority Data
May 27, 2019 (JP) 2019-098706

(51) Int. Cl. B29C 64/393; B33Y 10/00; B33Y 30/00; B33Y 50/02; B29C 64/118; B29C 64/209; B29C 64/321; B33Y 40/00

(52) U.S. Cl. CPC B29C 64/393; B33Y 10/00; B33Y 30/00; B33Y 40/00; B29C 64/118; B29C 64/209; B29C 64/321; B33Y 50/02

(57) ABSTRACT

A fabricating system includes a discharger, a measuring device, and a control device. The discharger is configured to discharge a fabricating material to perform fabrication. The measuring device is configured to measure a physical quantity at least related to a discharge resistance arising when the fabricating material is discharged from the discharger. The control device is configured to control a supply amount of the fabricating material supplied to the discharger based on the physical quantity measured by the measuring device.

### CROSS-REFERENCE TO RELATED APPLICATION

This patent application is based on and claims priority pursuant to 35 U.S.C. § 119(a) to Japanese Patent Application No. 2019-098706, filed on May 27, 2019, in the Japan Patent Office, the entire disclosure of which is incorporated by reference herein.

### BACKGROUND

### Technical Field

Aspects of the present disclosure relate to a fabricating technique, and more particularly, to a fabricating system, a control device, a fabricating method, and a storage medium storing program code for discharging a fabricating material to perform fabrication.

### Related Art

In a three-dimensional fabricating apparatus of, e.g., a fused filament fabrication (FFF) system, the amount of resin discharged from a nozzle portion is known to change depending on the speed of feeding a resin material to the nozzle portion heated. Attempts have been made to control the speed of feeding the resin material to obtain a desired shape.

### SUMMARY

In an aspect of the present disclosure, there is provided a fabricating system that includes a discharger, a measuring device, and a control device. The discharger is configured to discharge a fabricating material to perform fabrication. The measuring device is configured to measure a physical quantity at least related to a discharge resistance arising when the fabricating material is discharged from the discharger. The control device is configured to control a supply amount of the fabricating material supplied to the discharger based on the physical quantity measured by the measuring device.

In another aspect of the present disclosure, there is provided a fabricating method that include discharging, measuring, and operating. The discharging discharges a fabricating material from a discharger to perform fabrication. The measuring measures, with a measuring device, a physical quantity at least related to a discharge resistance in discharging the fabricating material. The operating operates a supply amount of the fabricating material supplied to the discharger, based on the physical quantity measured by the measuring device.

In another aspect of the present disclosure, there is provided a non-transitory computer-readable storage medium storing program code for controlling a fabricating apparatus to discharge a fabricating material to perform fabrication. The program code causes a computer to cause a measuring device to measure a physical quantity at least related to discharge resistance arising when the fabricating material is discharged from a discharger; and control a supply amount of the fabricating material supplied to the discharger, based on the physical quantity measured by the measuring device.

### BRIEF DESCRIPTION OF THE DRAWINGS

The aforementioned and other aspects, features, and advantages of the present disclosure would be better understood by reference to the following detailed description when considered in connection with the accompanying drawings, wherein:

FIG. 1 is a schematic view of a configuration of a three-dimensional fabricating apparatus according to an embodiment of the present disclosure;

FIG. 2 is a schematic view of a configuration of a head module of the three-dimensional fabricating apparatus;

FIG. 3 is a block diagram of a functional configuration of the three-dimensional fabricating apparatus;

FIG. 4 is a block diagram of a detailed configuration for controlling a resin feed amount while measuring discharge resistance;

FIGS. 5A and 5B are illustrations of factors that may cause variations in line width;

FIG. 6 is a diagram illustrating an example of a hardware configuration of a control device to control the three-dimensional fabricating apparatus;

FIG. 7 is a configuration of a head module according to another embodiment;

FIG. 8 is a configuration of a head module according to still another embodiment;

FIG. 9 is a flowchart of a fabricating method of controlling a resin feed amount while measuring discharge resistance, according to an embodiment of the present disclosure;

FIGS. 10A and 10B are graphs plotting the resin feed amount, the gap between the tip of a discharge nozzle and a lower surface, the reaction force generated in feeding of resin, and the line width of a fabricated road in a case where fabrication is performed at a constant resin feed amount without controlling the resin feed amount in response to the reaction force in the configuration of FIG. 7; and

FIGS. 11A and 11B are graphs plotting the resin feed amount, the gap between the tip of a discharge nozzle and a lower surface, the reaction force generated in feeding of resin, and the line width of a fabricated road in a case where the resin feed amount is controlled in response to the reaction force in the configuration of FIG. 7.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Although the embodiments are described with technical limitations with reference to the attached drawings, such description is not intended to limit the scope of the disclosure and all of the components or elements described in the embodiments of this disclosure are not necessarily indispensable.

Referring now to the drawings, embodiments of the present disclosure are described below. In the drawings for explaining the following embodiments, the same reference codes are allocated to elements (members or components) having the same function or shape and redundant descriptions thereof are omitted below.

Hereinafter, several embodiments of the present disclosure are described. However, embodiments of the present disclosure are not limited to the embodiments described below. In the following embodiments, a three-dimensional fabricating apparatus 1 of a fused deposition fabricating method that discharges a resin material to perform fabrication and includes a control device is described as an example of a fabricating system that discharges a fabricating material to perform fabrication. However, the fabricating system is not limited to the fabricating system described below.

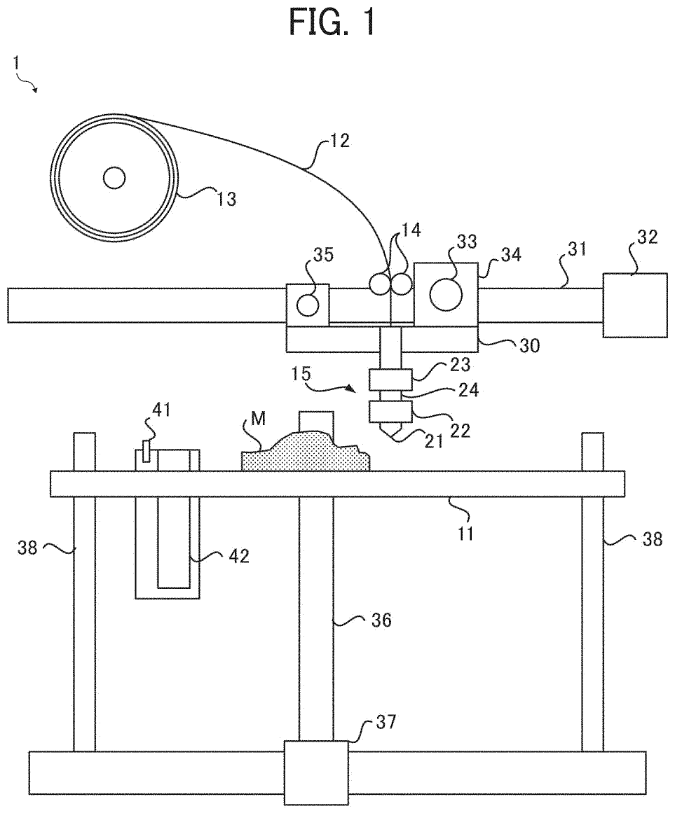

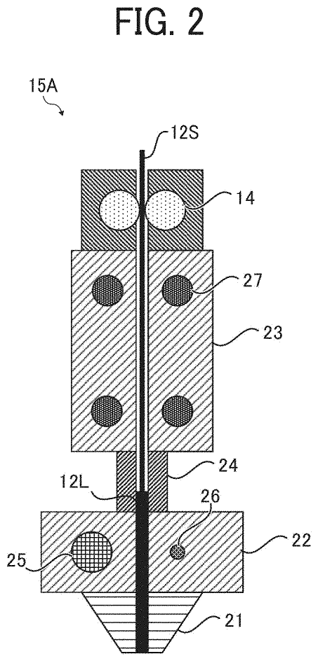

Hereinafter, a basic configuration of the three-dimensional fabricating apparatus 1 according to the present embodiment is described with reference to FIGS. 1 and 2.

FIG. 1 illustrates a schematic configuration of the three-dimensional fabricating apparatus 1 according to the present embodiment. The three-dimensional fabricating apparatus 1 according to the present embodiment has a configuration in which the inside of a housing is a processing space for fabricating a three-dimensional object. As illustrated in FIG. 1, the three-dimensional fabricating apparatus 1 includes a fabricating table 11 as a mount table, and a three-dimensional object M is fabricated on the fabricating table 11. A head module 15 as a fabricating head is disposed above the fabricating table 11 in the housing.

In the three-dimensional fabricating apparatus 1, a filament reel 13 is attached to the outside of the housing, and an extruder 14 is disposed in the head module 15. As the filament 12 is pulled by rotation of the extruder 14, the reel 13 rotates without exerting a large resistance force.

FIG. 2 illustrates a configuration of the head module 15 according to the present embodiment. As illustrated in FIGS. 1 and 2, the head module 15 includes a discharge nozzle 21 at a lower portion of the head module 15. The discharge nozzle 21 is a discharger to discharge a filament as a fabricating material. The head module 15 includes a heating block 22 to heat and melt the filament 12 supplied to the discharge nozzle 21. Furthermore, a cooling block 23 is provided above the heating block 22 to prevent a melted filament 12L from flowing back to an upper portion in the head module 15 and increasing the resistance in pushing out the filament 12 or prevent the solidified filament 12 from clogging a transfer path.

The heating block 22 includes a heat source 25 to generate heat and a thermocouple 26 to detect the temperature of the heating block 22. The heating block 22 heats and melts the filament 12 supplied to the discharge nozzle 21. The cooling block 23 is disposed above the heating block 22 and includes an appropriate cooling source 27 using, e.g., an air cooling mechanism or a water cooling mechanism to prevent the melted filament 12L from flowing back to the upper portion in the head module 15. A filament guide 24 to guide the filament 12 to the discharge nozzle 21 is provided between the heating block 22 and the cooling block 23. The discharge nozzle 21 illustrated in FIG. 2 is modularized together with various components such as the heating block 22, the cooling block 23, and the filament guide 24.

The filament 12 is a long, thin wire-shaped solid material, and is set in a wound state on the reel 13 of the three-dimensional fabricating apparatus 1. The extruder 14 is provided above the cooling block 23, thus allowing a filament 12S in a solid state to be drawn into the head module 15 and supplied to the discharge nozzle 21 of the head module 15 via the transfer path. In the present embodiment, as illustrated in FIG. 2, the filament 12 supplied via the transfer path is melted by the heating block 22, and the melted filament 12L being a resin material in a melted (liquid) state is discharged from the discharge nozzle 21. Accordingly, layered fabricated structures are sequentially laminated on the fabricating table 11 and the three-dimensional fabricated object M is fabricated.

Referring again to FIG. 1, the head module 15 is held by an X-axis drive shaft 33 and a guide shaft 35 extending in a front-rear direction of the three-dimensional fabricating apparatus 1 (a direction perpendicular to a paper surface of FIG. 1, that is, an X-axis direction) so as to be slidable along a longitudinal direction (X-axis direction) of the X-axis drive shaft 33 via an X-drive base 30. The head module 15 is movable along the front-rear direction (X-axis direction) of the three-dimensional fabricating apparatus 1 by the driving force of an X-axis drive motor 34. Further, since the head module 15 is heated to a high temperature by the heating block 22, the transfer path including the filament guide 24 preferably has low thermal conductivity so that the heat is not easily conducted to the X-axis drive motor 34.

The X-axis drive motor 34 is held by a Y-axis drive shaft 31 extending in a left-right direction of the three-dimensional fabricating apparatus 1 (a left-right direction in FIG. 1, that is, Y-axis direction) so as to be slidable along a longitudinal direction (Y-axis direction) of the Y-axis drive shaft 31. When the X-axis drive motor 34 is moved along the Y-axis direction by the driving force of the Y-axis drive motor 32, the head module 15 can be moved along the Y-axis direction.

The fabricating table 11 is passed through the Z-axis drive shaft 36 and the guide shaft 38 and is held movably along a longitudinal direction (Z-axis direction) of a Z-axis drive shaft 36 with respect to the Z-axis drive shaft 36 extending in a vertical direction of the three-dimensional fabricating apparatus 1 (a vertical direction in FIG. 1, that is, a Z-axis direction). The fabricating table 11 can be moved in the vertical direction (Z-axis direction) of the three-dimensional fabricating apparatus 1 by the driving force of a Z-axis drive motor 37.

The X-axis drive motor 34, the Y-axis drive motor 32, and the Z-axis drive motor 37 are operated to control the movement of the head module 15 and the fabricating table 11, thus allowing the relative three-dimensional positions of the head module 15 and the fabricating table 11 to move to target three-dimensional positions. In the present embodiment, the relative three-dimensional positions of the head module 15 and the fabricating table 11 are determined by controlling the movement of the head module 15 along the X-axis and the Y-axis and the movement of the fabricating table 11 along the Z-axis. However, embodiments of the present disclosure are not limited to such a configuration. For example, the fabricating table 11 may be fixed and the movement of the head module 15 may be controlled along the X axis, the Y axis, and the Z axis.

The three-dimensional fabricating apparatus 1 illustrated in FIG. 1 further includes a cleaning brush 41 and a dust box 42. When the filament 12 is continuously melted and discharged, the periphery of the discharge nozzle 21 may be contaminated with molten resin. The cleaning brush 41 periodically performs cleaning operation to prevent the resin from sticking to the tip of the discharge nozzle 21. From the viewpoint of preventing sticking, it is preferable that the cleaning operation is performed before the temperature of the resin is completely lowered. Therefore, a heat-resistant resin is preferably used for the cleaning brush 41. The dust box 42 accommodates polishing powder generated during the cleaning operation. The polishing powder accumulated in the dust box 42 is periodically discarded or discharged to the outside through a suction path.

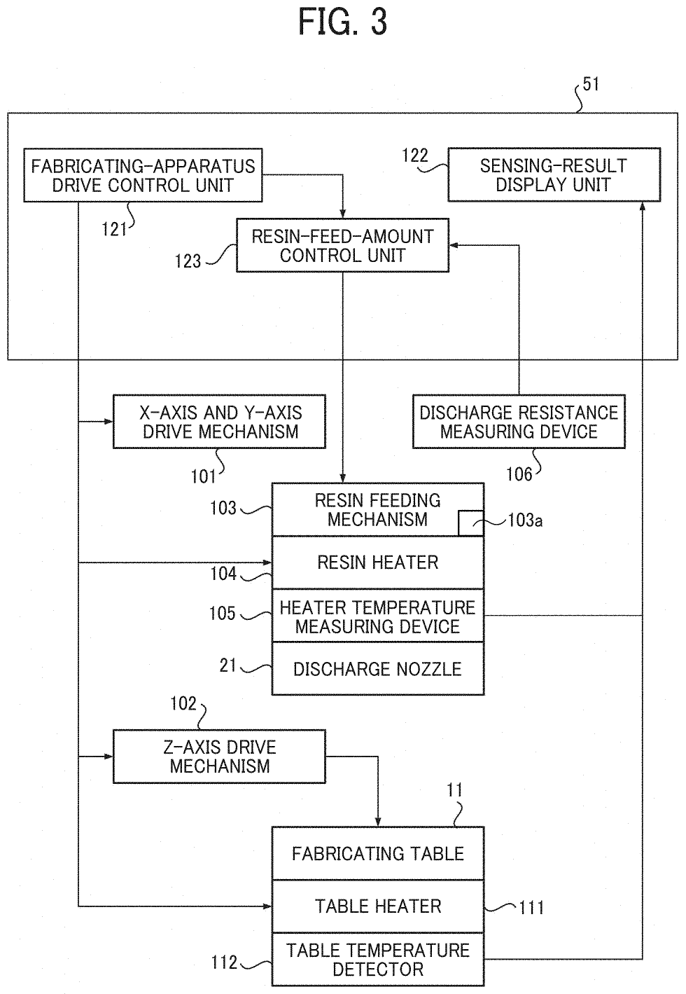

Hereinafter, discharge control performed by the three-dimensional fabricating apparatus 1 according to the present embodiment is described with reference to FIGS. 3 to 5B.

FIG. 3 is a block diagram illustrating a functional configuration of the three-dimensional fabricating apparatus 1 according to the present embodiment. The three-dimensional fabricating apparatus 1 according to the present embodiment includes an X-axis and Y-axis drive mechanism 101, a Z-axis drive mechanism 102, a resin feeding mechanism 103, a resin heater 104, a heater temperature measuring device 105, a discharge resistance measuring device 106, a table heater 111, and a table temperature detector 112.

The three-dimensional fabricating apparatus 1 according to the present embodiment includes a controller 51 as a control device. A fabricating-apparatus drive control unit 121, a sensing-result display unit 122, and a resin-feed-amount control unit 123 are configured on the controller 51. The controller 51 includes, for example, a central processing unit (CPU) to perform predetermined control arithmetic processing according to programs, a memory to store the programs and various data, and an interface connected to an external device, and achieves the above-described units such as the fabricating-apparatus drive control unit 121, the sensing-result display unit 122, and the resin-feed-amount control unit 123 by cooperation of the CPU, the memory, the interface, and so on.

The X-axis and Y-axis drive mechanism 101 controls the X-axis drive motor 34 and the Y-axis drive motor 32 in accordance with a control signal from the controller 51 to displace the head module 15 to a desired position on the XY plane. The X-axis and Y-axis drive mechanism 101 also detects the moving distances of the head module 15 in the X-axis direction and the Y-axis direction and transmits the detection results to the controller 51. The moving speed of the head module 15 can be calculated based on the detection results of the X-axis and Y-axis drive mechanism 101. The Z-axis drive mechanism 102 controls the Z-axis drive motor 37 based on a control signal from the controller 51 to displace the position of the fabricating table 11 in the Z-axis direction to a desired position.

The resin feeding mechanism 103 feeds the filament 12, which is the fabricating material, to the discharge nozzle 21 with the extruder 14 based on a control signal from the controller 51. The resin heater 104 heats the temperature of the discharge nozzle 21 and the filament 12 fed to the discharge nozzle 21 to a desired temperature based on a control signal from the controller 51. The heater temperature measuring device 105 detects the temperature of the resin heater 104 or a temperature related to the temperature of the resin heater 104 and transmits the detection result to the controller 51. In the present embodiment, the temperature of the resin heater 104 (heating block 22) is detected. In some embodiments, for example, the temperature of the filament 12 itself or the temperature of the discharge nozzle 21 may be detected.

The table heater 111 heats the fabricating table 11 to a desired temperature based on a control signal of the controller 51. The table temperature detector 112 detects the temperature of the fabricating table 11 or a table temperature that is a temperature related to the temperature of the fabricating table 11 and transmits the detection result to the controller 51. Examples of the table temperature include the temperature of the fabricating table 11 itself and the temperature of a mechanism (such as an electric heater) that heats the fabricating table 11.

The discharge resistance measuring device 106 measures a physical quantity at least related to a discharge resistance (force) arising when the resin material (molten filament 12) is discharged from the discharge nozzle 21, and transmits the measurement result to the controller 51. The magnitude of the discharge resistance may be directly measured as a physical quantity or may be indirectly measured by measuring a physical quantity that changes in relation to the discharge resistance. Examples of the physical quantity related to the discharge resistance include a torque with which a drive motor 103a as a power generator included in the extruder 14 (resin feeding mechanism 103) feeds the filament 12 to the discharge nozzle 21, a reaction force received from the discharge nozzle 21 via the filament 12 in response to the feeding of the filament 12, and a nozzle internal pressure generated in the discharge nozzle 21 in response to the feeding of the filament 12. The discharge resistance means the difficulty of discharge and can be defined as, for example, 1/{(resin discharge amount)/(resin supply amount)}. The magnitude of the discharge resistance can be directly measured by measuring the resin supply amount and the resin discharge amount in real time. Here, the resin discharge amount can be obtained by the product of the measured feeding speed and the cross-sectional area of the filament. The resin discharge amount can be determined, for example, by measuring the volume of the resin immediately after discharge, with an optical shape measuring device attached near a discharge port of the discharge nozzle 21. The discharge resistance may be directly measured if a direct measurement system can be constructed in layout.

With reference to FIG. 2, a description is given of a configuration for detecting the torque of the drive motor 103A used in the extruder 14 (resin feeding mechanism 103) that feeds the resin to the discharge nozzle 21 in the head module 15 illustrated in FIG. 2. The extruder 14 illustrated in FIG. 2 includes rollers and gears driven by an alternating current (AC) servo motor. When it is difficult to discharge the resin, that is, when the discharge resistance is large, the amount of the resin in a liquid chamber is large, and as a result, the force required for feeding the filament 12 is increased. Therefore, the magnitude of the discharge resistance can be measured by detecting the force for feeding the filament 12, that is, the torque of the drive motor 103a for driving the extruder 14.

The motor that can be used to measure the discharge resistance may be any motor such as an AC motor or a direct current (DC) motor as long as the motor can measure the torque or the current value. Alternatively, the torque of the motor may be directly measured by a measuring device such as a torque meter. A method of measuring the reaction force received through the filament 12 and a method of measuring the nozzle internal pressure generated in the discharge nozzle 21 in response to the feeding of the resin material are described in detail later.

A description is given with reference to FIG. 3 again. The resin-feed-amount control unit 123 determines the resin feed amount based on tool path data and controls the resin feeding mechanism 103. Here, the tool path data refers to data (for example, a G code) for operating the head module 15, which is obtained by slicing each layer from three-dimensional data (for example, data in a stereolithography (SLT) format) for forming a desired three-dimensional object M. The resin-feed-amount control unit 123 according to the present embodiment determines a final resin feed amount based on the resin feed amount determined in accordance with the tool path data and further based on the discharge resistance measured by the discharge resistance measuring device 106. Here, the resin feed amount is an operable amount such as the linear velocity of the filament 12.

The fabricating-apparatus drive control unit 121 transmits control signals to the X-axis and Y-axis drive mechanism 101 and the Z-axis drive mechanism 102 to control the movement of the head module 15 and the fabricating table 11, thereby moving the relative three-dimensional positions of the head module 15 and the fabricating table 11 to target three-dimensional positions. The sensing-result display unit 122 displays, for example, a result detected by the heater temperature measuring device 105 or the table temperature detector 112.

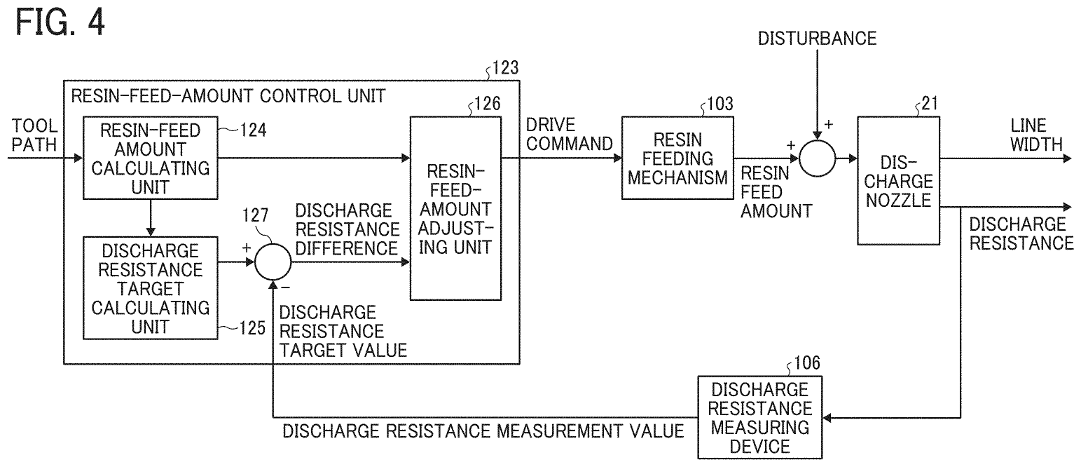

Hereinafter, with reference to FIG. 4, further descriptions are given of functions of the resin-feed-amount control unit 123, the resin feeding mechanism 103, the discharge resistance measuring device 106, and the discharge nozzle 21 involved in the resin feed control according to the present embodiment.

FIG. 4 is a block diagram of a detailed configuration for controlling the resin feed amount while measuring the discharge resistance. As illustrated in FIG. 4, the resin-feed-amount control unit 123 includes, for example, a resin-feed-amount calculating unit 124, a discharge resistance target calculating unit 125, a resin-feed-amount adjusting unit 126, and a subtractor 127.

The resin-feed-amount calculating unit 124 determines a reference resin feed amount (reference supply amount) based on the tool path data. Since the amount of resin (volume speed) discharged from the discharge nozzle 21 has a delay with respect to the speed at which the filament 12 is fed to the discharge nozzle 21, the resin-feed-amount calculating unit 124 adjusts the volume speed of the resin material entering the heating block 22 in accordance with a predetermined tool path so as to take into consideration the delay in resin discharge. The resin-feed-amount calculating unit 124 constitutes a supply amount calculating unit in the present embodiment. The determined reference resin feed amount is input to the discharge resistance target calculating unit 125 and the resin-feed-amount adjusting unit 126.

The discharge resistance target calculating unit 125 calculates a target value for approximating the discharge resistance to be measured based on the determined reference resin feed amount. The discharge resistance target calculating unit 125 constitutes a target value calculating unit in the present embodiment.

The resin-feed-amount control unit 123 controls the discharge resistance measuring device 106 to measure the physical quantity at least related to the discharge resistance arising when the filament 12 is discharged. The subtractor 127 calculates a difference between the target value of the discharge resistance calculated by the discharge resistance target calculating unit 125 and the discharge resistance measurement value detected by the discharge resistance measuring device 106 and inputs the calculated discharge resistance difference to the resin-feed-amount adjusting unit 126.

The resin-feed-amount adjusting unit 126 adjusts a final resin feed amount based on the reference resin feed amount and discharge resistance difference input from the subtractor 127. When the discharge resistance difference is large (the discharge resistance is smaller than the target value), the resin-feed-amount adjusting unit 126 adjusts the resin feed amount so as to increase the resin feed amount. By contrast, when the discharge resistance difference is small (a negative value), the resin-feed-amount adjusting unit 126 adjusts the resin feed amount so as to decrease the resin feed amount As described above, the resin-feed-amount adjusting unit 126 performs control so that the difference between the target value of the discharge resistance and the current detection value be zero. Examples of the control include, but are not particularly limited to, feedback control such as proportional-integral-differential (PID) control. The resin-feed-amount adjusting unit 126 constitutes an adjustment unit in the present embodiment.

The resin-feed-amount control unit 123 issues a resin feed amount command to the resin feeding mechanism 103 based on the final resin feed amount determined by the resin-feed-amount adjusting unit 126 and performs control so as to operate the resin feed amount supplied to the discharge nozzle 21. The resin-feed-amount control unit 123 constitutes a control unit or a supply amount control unit in the present embodiment.

The resin feeding mechanism 103 supplies the filament 12 to the discharge nozzle 21 in accordance with the instructed resin feed amount in response to the resin feed amount command. At this time, when the resin material is discharged from the discharge nozzle 21, a certain disturbance is applied, which might vary the line width of the discharged resin. Examples of the certain disturbance include variations in filament diameter and variations in gap between the tip of the discharge nozzle 21 and a lower surface due to roughness in fabrication of a lower layer of the discharge destination. Variations due to the disturbance also appear in the discharge resistance force.

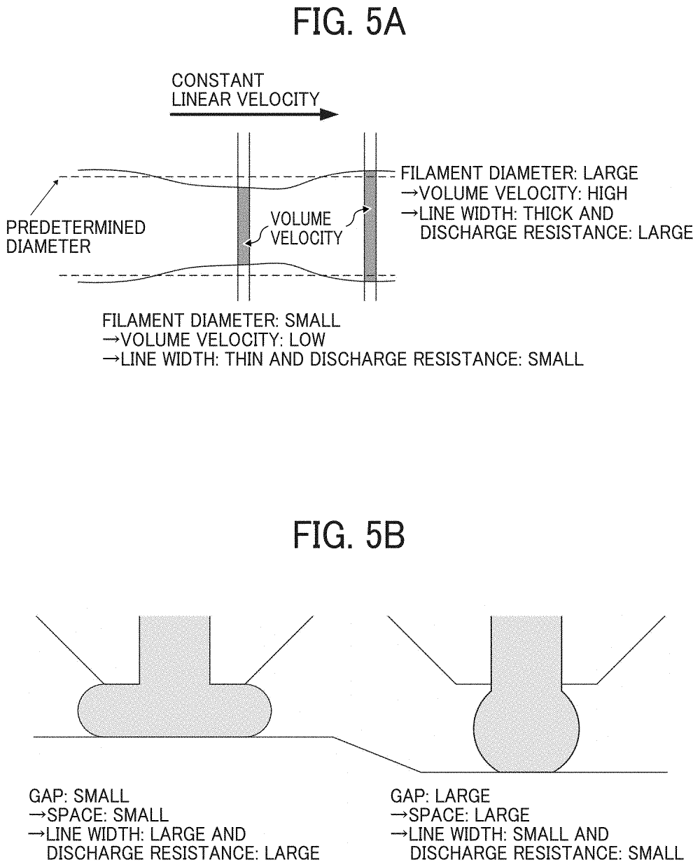

FIGS. 5A and 5B are diagrams illustrating factors that may cause variations in line width. FIG. 5A illustrates variations in line width due to variations in filament diameter. FIG. 5B illustrates variations in line width caused by variations in the gap between the tip of the discharge nozzle 21 and the lower surface.

The diameter of the filament is difficult to make completely uniform by the manufacturing process and may vary by several percent. When the actual diameter (solid line) of the filament is larger than the predetermined diameter (broken line) due to variations in filament diameter, as illustrated in FIG. 5A, the volume rate of the resin supplied to the discharge nozzle 21 increases even if the resin feed amount (for example, linear velocity) is constant. As a result, a larger amount of resin than the target amount is discharged from the discharge nozzle 21, that is, the volume rate of the resin discharge also increases, thus increasing the line width. At the same time, a larger amount of resin than assumed is discharged, and as a result, the discharge resistance also increases. By contrast, when the actual diameter (solid line) of the filament is smaller than the predetermined diameter (broken line), the volume velocity of the resin supplied to the discharge nozzle 21 is decreased, and the line width is narrowed. Thus, there is a positive correlation between the line width and the discharge resistance.

In addition, when the gap between the tip of the discharge nozzle 21 and the lower surface becomes small, as illustrated in FIG. 5B, the space to which the resin is discharged becomes narrow. Accordingly, the resin is discharged so as to spread the resin that has already been discharged, and the line width becomes thick. As a result, the resin is less likely to be discharged as compared with a state in which there is no resin immediately below the nozzle, and the discharge resistance increases. At the same time, as the resin is less likely to be discharged, the thickness of the road (the road created by the discharged resin) decreases and the line width increases.

As described above, even when the resin feed amount (linear velocity) is constant, the line width varies due to the filament diameter and the gap between the nozzle tip and the lower surface. The discharge resistance is correlated with the change in the line width, and the discharge resistance changes as the distance between the tip portion of the discharge nozzle 21 and the fabricating surface or the filament diameter changes. In the present embodiment, the physical quantity at least related to the discharge resistance is measured, and the resin feed amount is controlled so that the difference between the target value of the discharge resistance and the current measured value approaches zero. Maintaining the discharge resistance at the target value can reduce the influence of the above-described disturbances and control the line width to be constant. In addition, when the line width is uniform, the bonding area with the road becomes uniform between the upper layer and the lower layer. Accordingly, the occurrence of cracks (defects) that cause a decrease in the strength in the stacking direction (lamination direction) is reduced, and the tensile strength in the stacking direction is enhanced.

In the embodiment illustrated in FIGS. 3 and 4, the resin-feed-amount control unit 123 and the sub-modules thereof are realized by the controller 51 incorporated in the three-dimensional fabricating apparatus 1. However, the configuration of the fabricating system is not limited to the above-described configuration. For example, the resin-feed-amount control unit 123, the fabricating-apparatus drive control unit 121, and the like may be realized by an external computer connected to the three-dimensional fabricating apparatus 1. In such a case, the three-dimensional fabricating apparatus 1 and the external computer as a control apparatus connected to the three-dimensional fabricating apparatus 1 constitute a fabricating system. Such a configuration can achieve the same function as the functional configuration example illustrated in FIG. 3.

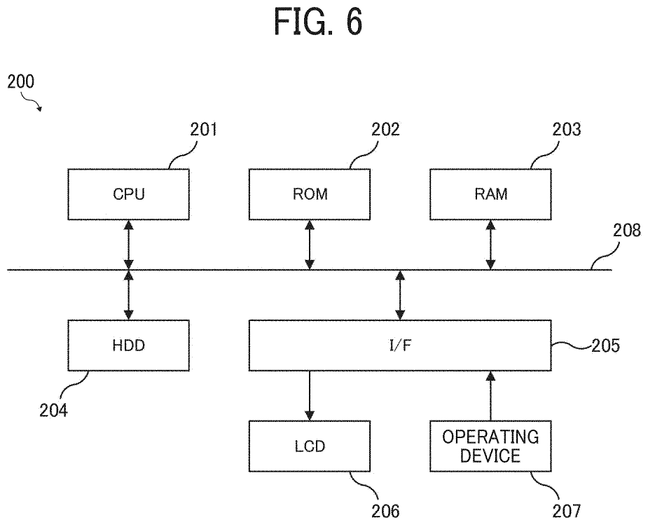

With reference to FIG. 6, a hardware configuration of the external computer as a control apparatus is described. A computer 200 has the same configuration as a general personal computer. For example, the computer 200 includes a central processing unit (CPU) 201, a read only memory (ROM) 202, a random access memory (RAM) 203, a hard disk drive (HDD) 204, an interface (I/F) 205, a liquid crystal display (LCD) 206, and an operating device 207. The CPU 201, the ROM 202, the RAM 203, the HDD 204, and the I/F 205 are connected to each other via a bus 208. The HDD 204 may be any storage device such as a solid state drive (SSD) as long as it is a nonvolatile storage device.

The CPU 201 is an arithmetic unit and controls the entire operation of the computer 200. The ROM 202 is a read-only nonvolatile storage medium and stores programs such as a boot program and firmware for controlling hardware. The RAM 203 is a volatile storage medium capable of high-speed reading and writing of information, and is used as a work area when the CPU 201 processes information. The HDD 204 is a non-volatile storage medium capable of reading and writing information, and stores an operating system (OS), various programs, various data, and the like.

The I/F 205 connects the bus 208 to various hardware, networks, and the like, and controls input and output and transmission and reception of information. The 205 can include a network I/F for allowing the computer 200 to communicate with other apparatuses via the network. As the network I/F, Ethernet (registered trademark), a universal serial bus (USB) interface, or the like can be used. The LCD 206 is a visual user interface for the user to check the state of the computer 200, and the operating device 207 is a user interface such as a keyboard or a mouse for the user to input information to the computer 200.

The computer 200 has functional units that implement various functions as the CPU 201 performs an arithmetic operation according to a program stored in the ROM 202 or a program read from the HDD 204 or a storage medium such as an optical disc to the RAM 203. Note that all of the functional units may be implemented by execution of the program, a part of the functional units may be implemented by execution of the program the other part may be implemented by hardware such as a circuit, or all of the functional units may be implemented by hardware.

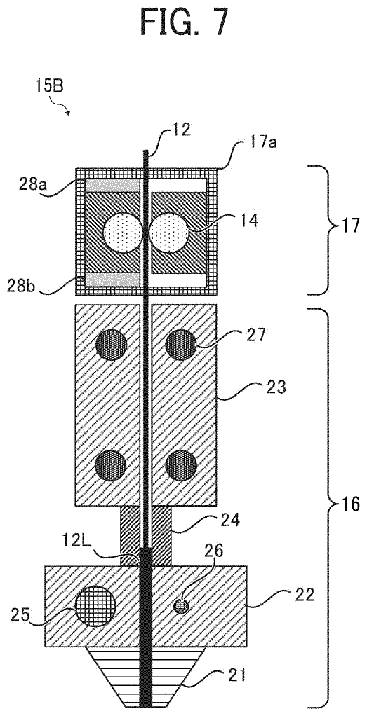

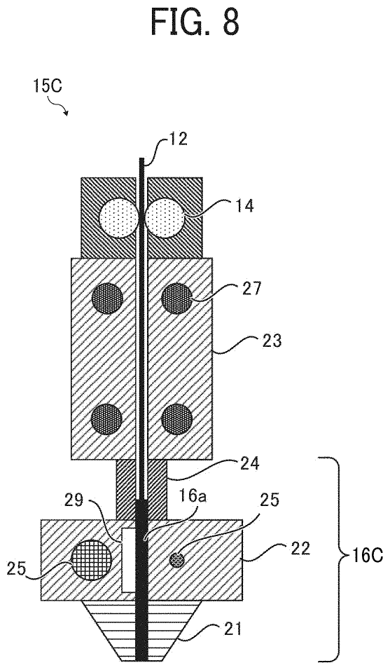

Hereinafter, with reference to FIGS. 7 and 8, a description is given of a method of detecting a physical quantity related to the discharge resistance (force) other than the method of detecting the torque of the drive motor 103a used in the extruder 14 (resin feeding mechanism 103) that feeds the filament 12 to the discharge nozzle 21.

FIG. 7 illustrates a configuration of the head module 15B according to another embodiment. The head module 15B according to another embodiment illustrated in FIG. 7 can measure a reaction force received via the filament 12 described above.

As illustrated in FIG. 7, the head module 15 includes a nozzle unit 16 and a feeding unit 17 that are mechanically independent of each other. The nozzle unit 16 includes a discharge nozzle 21, a heating block 22, a cooling block 23, and a filament guide 24. The feeding unit 17 as a feeder includes a feeding roller and a guide roller of the extruder 14 (resin feeding mechanism 103).

As illustrated in FIG. 7, the feeding unit 17 includes two pressure sensors 28a and 28b (collectively referred to as pressure sensors 28 unless distinguished) in an exterior 17a. The pressure sensors 28 serve as the discharge resistance measuring devices 106 to measure, as a physical quantity, a force (reaction force) received from the discharge nozzle 21 (nozzle unit 16) via the filament 12 by the feeding unit 17 having the resin feeding mechanism 103. The pressure sensors 28 detect the pressure in the compression direction. When the filament is fed toward a liquid chamber, the pressure sensor 28a detects the reaction force. When the filament is pulled in a direction opposite to the liquid chamber, the pressure sensor 28b detects the pressure. Providing the two pressure sensors 28a and 28b allows detection of bidirectional reaction forces. As in the embodiment in which the torque of the motor is measured, the reaction force increases when the discharge resistance is high. That is, the discharge resistance and the reaction force change with a positive correlation. Therefore, measuring the reaction force allows the magnitude of the discharge resistance to be measured. As the pressure sensors 28, any sensor capable of measuring pressure, such as a piezoelectric element or a strain gauge, can be used.

FIG. 8 illustrates a configuration of a head module 15C according to still another embodiment. The head module 15C according to still another embodiment illustrated in FIG. 8 can measure the nozzle internal pressure generated inside the discharge nozzle 21 in accordance with the feeding of the filament 12 described above.

Here, a portion of the nozzle portion 16C (including the discharge nozzle 21, the heating block 22, and the filament guide 24) in which the molten (liquid) filament is stored is referred to as a liquid chamber 16a. As illustrated in FIG. 8, the liquid chamber 16a is provided with a pressure sensor 29 to detect the internal pressure of the liquid chamber 16a. In the embodiment illustrated in FIG. 8, the pressure sensor 29 serves as the discharge resistance measuring device 106 and measures, as a physical quantity, the pressure inside the liquid chamber 16a inside the discharge nozzle 21 where the resin melts.

When the discharge resistance becomes high, the resin becomes difficult to be discharged. On the other hand, the amount of resin (volume flow rate) fed into the liquid chamber 16a by the extruder 14 does not change and is constant. Therefore, the amount of resin in the liquid chamber 16a increases, and the pressure in the liquid chamber 16a increases. That is, the discharge resistance and the nozzle internal pressure change with a positive correlation. Therefore, measuring the nozzle internal pressure allows the magnitude of the discharge resistance to be measured.

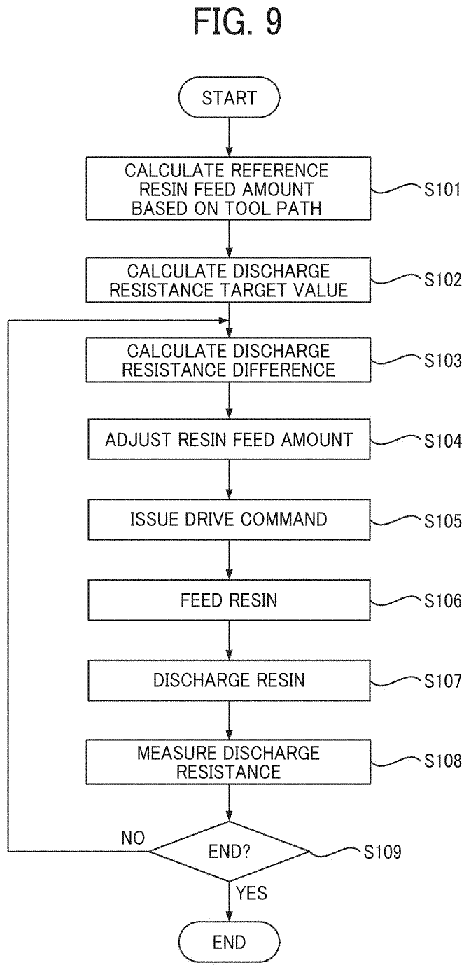

Hereinafter, with reference to FIG. 9, a description is given of a fabricating method according to the present embodiment in which the resin feed amount is controlled while measuring the discharge resistance. The control illustrated in FIG. 9 is started from step S100 in response to a fabricating instruction.

In step S101, the resin-feed-amount calculating unit 124 calculates the reference resin feed amount based on predetermined tool path data. In step S102, the discharge resistance target calculating unit 125 calculates a discharge resistance target value based on the calculated reference resin feed amount. The discharge resistance target value changes depending on the tool path but is uniquely obtained by the tool path. For example, the target discharge resistance is increased in a path having a high fabricating speed.

In step S103, the subtractor 127 calculates the discharge resistance difference between the target value of the discharge resistance and the measured discharge resistance value. In the first loop, since the discharge resistance is not measured, for example, the discharge resistance may be calculated as having no difference. In step S104, the resin-feed-amount adjusting unit 126 adjusts the reference resin feed amount based on the reference resin feed amount calculated in step S102 and the discharge resistance difference calculated in step S103 and determines the final resin feed amount.

In step S105, the resin-feed-amount control unit 123 issues a drive command to the resin feeding mechanism 103 at the final resin feed amount determined in step S104. In step S106, the resin feeding mechanism 103 operates the resin feed amount in response to the drive command and feeds the filament 12 at the determined final resin feed amount. In step S107, the resin is discharged from the discharge nozzle 21. In step S108, the discharge resistance measuring device 106 measures a physical quantity at least related to the discharge resistance arising when the resin material is discharged from the discharge nozzle 21.

In step S109, the controller 51 determines whether to end the current control. In step S109, for example, if the controller 51 determines that the instructed fabricating process is still in progress and the current control is not to be ended (NO), the process loops to step S103. Alternatively, if the controller 51 determines in step S109 that, for example, the instructed fabricating process is completed and the current control is to be ended (YES), the process proceeds to step S110 and the current process is ended.

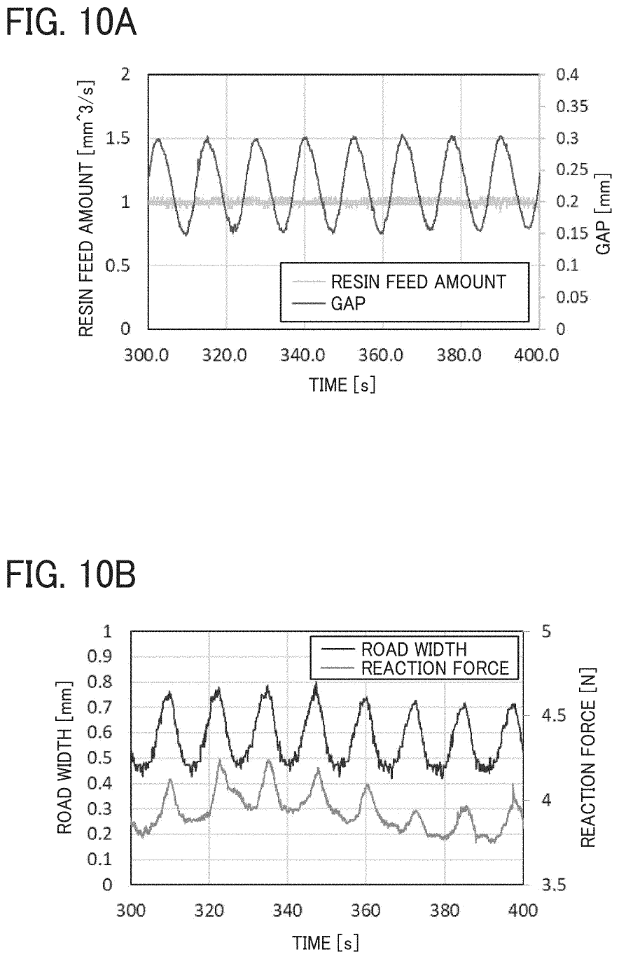

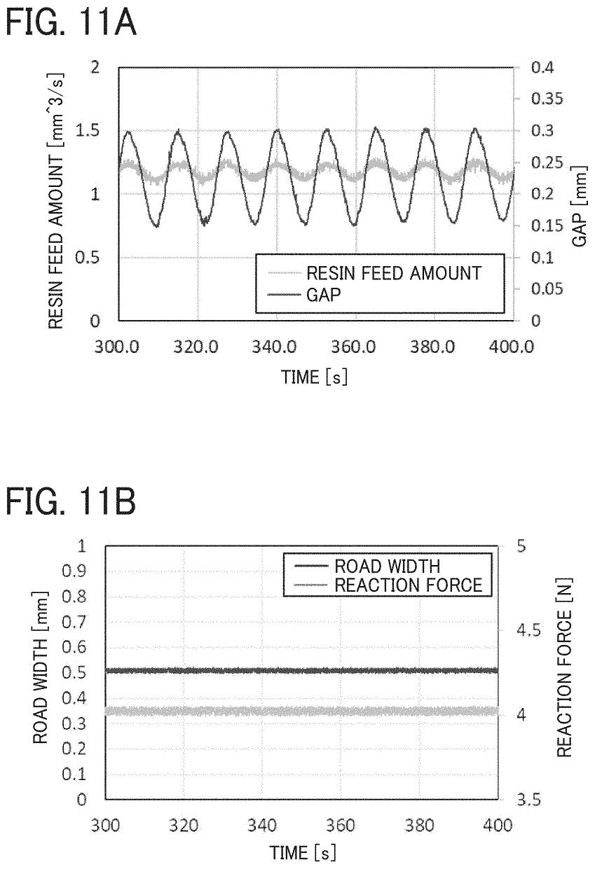

Hereinafter, with reference to FIGS. 10A and 10B and FIGS. 11A and 11B, a description is given of a fabrication result in a case where the resin feed amount is controlled according to the physical quantity related to the discharge resistance and a fabrication result in a case where the resin feed amount is not controlled according to the physical quantity related to the discharge resistance, by taking a case where the reaction force is used as the physical quantity as an example.

FIGS. 10A and 10B are graphs plotting the resin feed amount (gray line in FIG. 10A), the gap between the tip of the discharge nozzle 21 and the lower surface (black line in FIG. 10A), the reaction force generated at the feeding of resin (gray line in FIG. 10B), and the line width of the fabricated road (black line in FIG. 10B) in a case where fabrication is performed at a constant resin feed amount without controlling the resin feed amount in response to the reaction force in the configuration of FIG. 7. Here, as the disturbance, the fabrication is performed in an environment in which the gap (interval) between the tip of the discharge nozzle 21 and the lower surface periodically varies. As can be understood from a comparison between the black line in FIG. 10A and the black line and the gray line in FIG. 10B, in the case where fabrication is performed at a constant resin feed amount, the reaction force and the line width become large at a portion where the gap becomes small, and fabricating is not performed with a target line width.

FIGS. 11A and 11B are graphs plotting the resin feed amount (gray line in FIG. 11A), the gap between the tip of the discharge nozzle 21 and the lower surface (black line in FIG. 11A), the reaction force generated at the feeding of resin (gray line in FIG. 11B), and the line width of the fabricated road (black line in FIG. 11B) in a case where fabrication is performed while controlling the resin feed amount in response to the reaction force in the configuration of FIG. 7. As can be seen from a comparison between the black line and the gray line in FIG. 11A, the resin feed amount changes in accordance with the variations of the gap. As can be understood by referring to the black line and the gray line in FIG. 11A, controlling the resin feed amount to maintain the reaction force constant causes the line width and the discharge resistance to be constant. Thus, it is understood that the target line width is stably fabricated.

As described above, according to the above-described embodiments, there can be provided a fabricating system, a control device, a fabricating method, and a program capable of further reducing the influence of variations of the line width and further stabilizing the line width of the fabricated object.

As described above, when the distance between the nozzle tip portion and the fabricating surface is not uniform due to the roughness of fabrication of the lower layer, the line width changes according to the change in the distance, and it may be difficult to perform fabricating with a uniform line width. In addition, due to variations in the size of the resin material (the diameter of the filament), the discharge amount varies depending on the amount of resin discharged from the nozzle portion, and it may be difficult to form a uniform line width.

However, according to the fabricating system of the above-described embodiment, variations in the line width caused by such variations can be suitably reduced and it is expected to enhance the fabricating quality. Furthermore, since variations in line width can be reduced, the bonding area between the upper layer and the lower layer can be made uniform, and enhancement in strength in the stacking direction is expected.

In the embodiments described above, the example has been described of the three-dimensional fabricating apparatus 1 of fused deposition fabricating type that discharges the resin material (filament 12) in a molten state from the discharge nozzle 21 of the head module 15 to perform fabrication. However, the fabricating system is not limited to the above-described three-dimensional fabricating apparatus of the fused deposition fabricating type and may be any fabricating system in which fabricating is performed by discharging a fabricating material from a discharger with a predetermined discharge resistance, and a supply amount of the fabricating material to be supplied to the discharger is controllable.

The above-described functional units can be realized by computer-executable programs written in a legacy programming language or an object-oriented programming language such as assembler, C, C++, C#, or Java (registered trademark). The programs can be stored in a device-readable recording or storage medium such as a read only memory (ROM), an electrically erasable programmable read-only memory (EEPROM), and an erasable programmable read-only memory (EPROM), a flash memory, a flexible disk, a compact disk read only memory (CD-ROM), a compact disk rewritable (CD-RW), a digital versatile disc read only memory (DVD-ROM), a digital versatile disc random access memory (DVD-RAM), a digital versatile disc rewritable (DVD-RW), a Blu-ray disk, a secure digital (SD card), or a magnetooptic disk (MO), or distributed through an electric communication line. A part or all of the functional units can be implemented on a programmable device (PD) such as a field programmable gate array (FPGA) or can be implemented as an application-specific integrated circuit (ASIC). Alternatively, a part or all of the functions of each embodiment of the present disclosure can be distributed by a recording or storage medium as circuit configuration data (bit stream data) to be downloaded to the PD to achieve the functional units on the PD or data described in the hardware description language (HDL), very high speed integrated circuits hardware description language (VHDL), or Verilog-HDL for generating the circuit configuration data.

Although some embodiments of the present disclosure have been described above, embodiments of the present disclosure are not limited to the above-described embodiments. The above-described embodiments of the present disclosure may be modified within a range that can be conceived by those skilled in the art. Examples of the modification include other embodiments, additions, modifications, and deletions. The modification is included in the scope of the present disclosure as long as the functions and effects of the present disclosure are obtained.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

1. A fabricating system comprising:
a discharger configured to discharge a fabricating material to perform fabrication;
a measuring device configured to measure a physical quantity at least related to a discharge resistance arising when the fabricating material is discharged from the discharger; and
a control device configured to control a supply amount of the fabricating material supplied to the discharger based on the physical quantity measured by the measuring device.

2. The fabricating system according to claim 1,
wherein the control device is configured to perform feedback control for operating the supply amount of the fabricating material so that the physical quantity measured by the measuring device becomes a target value.

3. The fabricating system according to claim 1, further comprising a feeding mechanism including a power generator to feed the fabricating material to the discharger, wherein the measuring device is configured to measure a torque of the power generator of the feeding mechanism as the physical quantity.

4. The fabricating system according to claim 1, further comprising a feeder that is mechanically independent of the discharger and includes a feeding mechanism configured to feed the fabricating material to the discharger, wherein the measuring device is configured to measure, as the physical quantity, a reaction force received by the feeder from the discharger via the fabricating material.

5. The fabricating system according to claim 1,
wherein the discharger includes a liquid chamber configured to store the fabricating material in a liquid state, and the measuring device is configured to measure an internal pressure of the liquid chamber as the physical quantity.

6. The fabricating system according to claim 1,
wherein the control device is configured to:
calculate a reference supply amount of the fabricating material based on tool path data;
calculate, based on the reference supply amount, a target value for approximating the physical quantity measured by the measuring device; and
adjust the supply amount of the fabricating material based on the reference supply amount of the fabricating material and a difference between the physical quantity measured by the measuring device and the target value.

7. The fabricating system according to claim 1,
wherein the fabricating system includes a three-dimensional fabricating apparatus of a fused deposition fabricating system, the fabricating material is a resin material, and
the discharger is a discharge nozzle included in a fabricating head of the three-dimensional fabricating apparatus, to discharge the resin material in a molten state.

8. A control device for controlling a fabricating apparatus configured to discharge a fabricating material to perform fabrication, the control device comprising processing circuitry configured to:
cause a measuring device to measure a physical quantity at least related to a discharge resistance arising when the fabricating material is discharged from a discharger of the fabricating apparatus; and
control a supply amount of the fabricating material supplied to the discharger based on the physical quantity measured by the measuring device.

9. The control device according to claim 8, wherein the physical quantity is a magnitude of resistance for discharging the fabricating material from the discharger, a torque in feeding of the fabricating material, a reaction force in response to feeding of the fabricating material, or a nozzle internal pressure in response to feeding of the fabricating material.

10. A fabricating method comprising:
discharging a fabricating material from a discharger to perform fabrication;
measuring, with a measuring device, a physical quantity at least related to a discharge resistance in discharging the fabricating material; and
operating a supply amount of the fabricating material supplied to the discharger, based on the physical quantity measured by the measuring device.
